(19) United States
(12) Patent Application Publication
(10) Pub. No.: US 2025/0073836 A1
(43) Pub. Date: Mar. 6, 2025

(54) CHECKING DEVICE INCLUDING SUPPORT MEMBER

(71) Applicant: SK On Co., Ltd., Seoul (KR)

(72) Inventors: Chae Won NA, Daejeon (KR); Jin Woo SON, Daejeon (KR); Hyo Seong AN, Daejeon (KR); Su A KIM, Daejeon (KR)

(21) Appl. No.: 18/809,343

(22) Filed: Aug. 20, 2024

(30) Foreign Application Priority Data
Aug. 28, 2023 (KR) 10-2023-0112622

(51) Int. Cl. B23Q 3/18

(52) U.S. Cl. CPC B23Q 3/186; B25B 1/14; B23Q 2703/02

(57) ABSTRACT

A checking device is disclosed. In some implementations, the checking device may include a clamp including a base and a linkage structure connected to the base, a first support member fastened to the base, the first support member having a through-hole corresponding to a fastening hole of an object, and a second support member connected to the linkage structure, the second support member moving relative to the first support member, based on movement of the linkage structure. The second support member may oppose the first support member with the object interposed therebetween. The through-hole may accommodate a checking pin passing through the through-hole and the fastening hole.

### CROSS-REFERENCE TO RELATED APPLICATION(S)

This patent document claims the priority and benefits of Korean Patent Application No. 10-2023-0112622 filed on Aug. 28, 2023, the disclosure of which is incorporated herein by reference in its entirety.

### TECHNICAL FIELD

The present disclosure generally relates to a checking device including a support member.

### BACKGROUND

Unlike primary batteries, secondary batteries may be charged and discharged, and thus may be applied to devices within various fields, such as digital cameras, mobile phones, laptops, and hybrid vehicles. Secondary batteries include nickel-cadmium batteries, nickel-metal hydride batteries, nickel-hydrogen batteries, lithium secondary batteries, and the like.

Lithium secondary batteries have been manufactured as pouch-type battery cells having flexibility, prismatic battery cells having rigidity, or cylindrical can-type battery cells. A plurality of battery cells may be stacked to form a cell assembly. The cell stack may be accommodated in a module housing to form a battery module. In addition, a plurality of battery modules may be accommodated in a pack housing to form a battery pack. During a quality checking process, dimensions of a component (for example, a housing) of a battery device (for example, a battery module or a battery pack) may be inspected.

### SUMMARY

For quality checking of an object (for example, a housing of a battery device), it may be necessary to fix of a position of the object. However, depending on a shape of the object, it may not be easy to fix the position using a clamp. In addition, when an object having a fastening hole is used, the fastening hole may not be visible by a clamp, such that it may not be easy to determine a position of the fastening hole.

According to an aspect of the present disclosure, provided is a checking device including a clamp capable of fixing a position of an object.

According to another aspect of the present disclosure provided is a checking device capable of checking a position of a hole formed in an object while a position of an object is fixed.

A battery module and a battery pack, manufactured using a checking device of the present disclosure, may be widely applied in the field of green technology, such as to electric vehicles, battery charging stations, and other battery-utilizing solar power generation schemes, wind power generation schemes, or the like. In addition, the battery module and the battery pack, manufactured using the checking device of the present disclosure, may be used in eco-friendly electric vehicles, hybrid vehicles, and the like, to prevent climate change by suppressing air pollution and greenhouse gas emissions.

In some embodiments of the present disclosure, a checking device may include a clamp including a base and a linkage structure connected to the base, a first support member configured to be fastened to the base, the first support member having a through-hole corresponding to a fastening hole of an object, and a second support member connected to the linkage structure, the second support member configured to move relative to the first support member, based on movement of the linkage structure. The second support member may face the first support member with the object interposed therebetween. The through-hole may accommodate a checking pin configured to pass through the through-hole and the fastening hole.

The second support member may have an accommodation groove accommodating at least a portion of the checking pin.

The second support member may include a connection portion connected to the linkage structure, and a pressurization portion extending from the connection portion, the pressurization portion defining the accommodation groove. The pressurization portion is configured to contact with the object.

The first support member may be detachably coupled to the base using a fastening member.

The first support member may have a first surface configured to contact with the object, and a second surface opposite the first surface, the second surface configured to contact with a protruding region of the checking pin.

The through-hole of the first support member may be formed to have a first length, and the checking pin may be formed to have a second length, longer than the first length.

The clamp may include a grip portion connected to the linkage structure, the grip portion for obtaining a user input. The linkage structure may include a first bar and a second bar respectively connected to the base and the grip portion.

The first bar may be connected to the base about a first axis, and may be connected to the grip portion about a second axis. The second bar may be connected to the grip portion about a third axis, and may be connected to the base about a fourth axis.

In some embodiments of the present disclosure, a checking device may include a clamp including a base and a linkage structure movably connected to the base, a first support member configured to be fastened to the base, the first support member having a through-hole to correspond to a fastening hole of an object, a second support member connected to the linkage structure, the second support member configured to move relative to the first support member, based on movement of the linkage structure, and a checking pin inserted into the through-hole and the fastening hole, the checking pin configured to face the second support member.

The second support member configured to face the first support member with the object interposed therebetween.

The checking pin may have a first end opposing the second support member, a protruding region, and a second end opposite the first end.

The second support member may have an accommodation groove configured to accommodate at least a portion of the checking pin.

The second support member may include a connection portion connected to the linkage structure, and a pressurization portion extending from the connection portion, the pressurization portion defining the accommodation groove. The pressurization portion is configured to contact with the object.

The first support member may be detachably coupled to the base using a fastening member.

The clamp may include a grip portion connected to the linkage structure, the grip portion for obtaining a user input. The linkage structure may include a first bar and a second bar respectively connected to the base and the grip portion. The first bar may be connected to the base about a first axis, and may be connected to the grip portion about a second axis. The second bar may be connected to the grip portion about a third axis, and may be connected to the base about a fourth axis.

According to an embodiment of the present disclosure, a position of a hole formed in an object may be inspected while a position of the object is fixed.

According to an embodiment of the present disclosure, a postural binding force for an object may be increased.

According to an embodiment of the present disclosure, position checking accuracy of an object may be increased.

### BRIEF DESCRIPTION OF DRAWINGS

Certain aspects, features, and advantages of the present disclosure are illustrated by the following detailed description with reference to the accompanying drawings.

FIG. 1 is a perspective view of a battery device according to an embodiment.

FIG. 2 is a perspective view of a housing according to an embodiment.

FIG. 3 is a schematic diagram of a checking device according to an embodiment.

FIGS. 4 and 5 are diagrams of a checking process of a checking device assembly according to an embodiment.

FIG. 6 is a perspective view of a checking device assembly according to an embodiment.

### DETAILED DESCRIPTION

Features of the present disclosure disclosed in this patent document are described by example embodiments with reference to the accompanying drawings. However, the features are merely exemplary, and the present disclosure is not limited to the specific embodiments described herein.

The words and terminologies used in the specification and claims should not be construed with common or dictionary meanings, but construed as meanings and conception coinciding the spirit of the present disclosure under a principle that the inventor(s) may appropriately define the conception of the terminologies to explain the present disclosure in the optimum method.

Therefore, embodiments described in the specification and the configurations illustrated in the drawings are not more than the most preferred embodiments of the present disclosure and do not fully cover the spirit of the present disclosure. Accordingly, it should be understood that there may be various equivalents and modifications that may replace those when the present application is filed.

Hereinafter, preferred embodiments of the present disclosure will be described in detail with reference to the accompanying drawings. In this case, it should be noted that the same components are denoted by the same reference numerals in the accompanying drawings. In addition, detailed descriptions of well-known functions and configurations that may obscure the gist of the present disclosure will be omitted. In addition, some components are exaggerated, omitted, or schematically illustrated in the accompanying drawings, and the size of each component does not fully reflect the actual size.

The present disclosure may be implemented in some embodiments to provide a checking device including a support member.

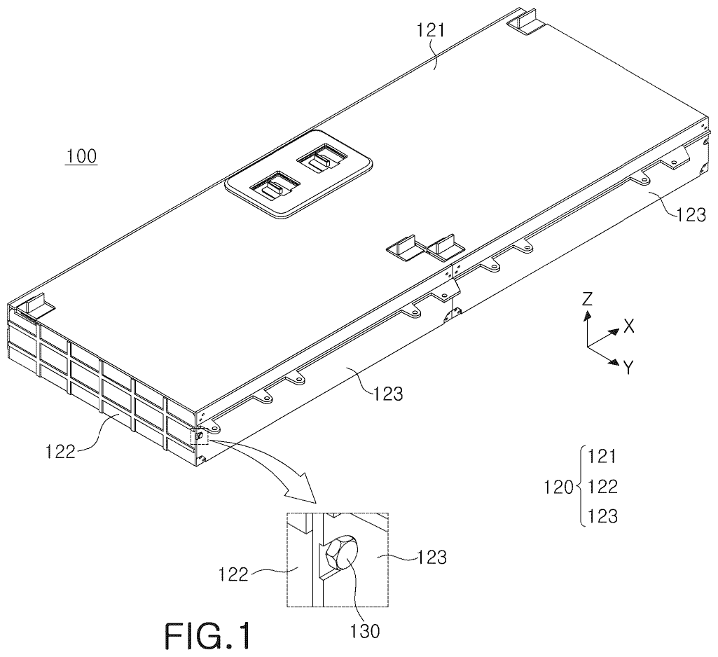

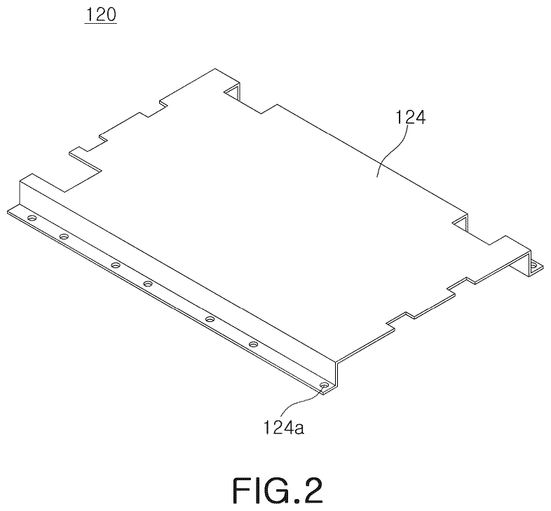

FIG. 1 is a perspective view of a battery device according to an embodiment. FIG. 2 is a perspective view of a housing according to an embodiment.

Referring to FIGS. 1 and/or 2, a battery device 100 may include at least one cell assembly (not illustrated), and a housing 120 accommodating the cell assembly.

The battery device 100 may be a battery module or a battery pack. For example, the battery device 100 may include a plurality of battery cells (not illustrated).

The battery cell may be a secondary battery cell.

For example, the battery cell may be a lithium-ion battery, but the present inventive concept is not limited thereto.

For example, the battery cell may be a nickel-cadmium electric cell, a nickel-metal hydride cell, or a nickel-hydrogen cell capable of being charged and discharged.

The cell assembly may include a plurality of battery cells. The battery cell may include an electrode assembly and a case accommodating the electrode assembly. A shape of the battery cell may be exemplary. For example, a pouch-type case, a prismatic case, a cylindrical case, a coin-type case, or the like may be used. According to exemplary embodiments, the electrode assembly may be formed by repeatedly disposing a cathode, an anode, and a separator. In some embodiments, the electrode assembly may be a winding-type electrode assembly, a stacking-type electrode assembly, a Z-fold type electrode assembly, or a stack-folding type electrode assembly.

The housing 120 may form at least a portion of the exterior of the battery device 100, and may protect at least a portion of the cell assembly.

According to an embodiment, the housing 120 may cover at least a portion of the cell assembly. For example, the housing 120 may include an upper cover 121, an end cover 122 covering at least one end of the cell assembly, and at least one side cover 123 covering one side surface of the cell assembly.

According to an embodiment, at least some covers, among the upper cover 121, the end cover 122, and the side cover 123, may be coupled to each other. For example, the end cover 122 may be coupled to the side cover 123 using a bolting method. For example, the end cover 122 and the side cover 123 may respectively have at least one fastening hole, and may be coupled to each other through a fastening member 130 inserted into the fastening hole. The fastening member 130 may have a screw, bolt, or boss structure.

Referring to an embodiment (for example, FIG. 2), the housing 120 may include a plate 124 having at least one fastening hole 124a. The plate 124 may be a portion (for example, the upper cover 121 or a lower plate (not illustrated)) of the housing 120. The fastening hole 124a may face a portion (for example, the end cover 122 or the side cover 123) of the housing 120, and the plate 124 may be coupled to the end cover 122 or the side cover 123 using a fastening member inserted into the fastening hole 124a.

The battery device 100 of FIG. 1 may be exemplary.

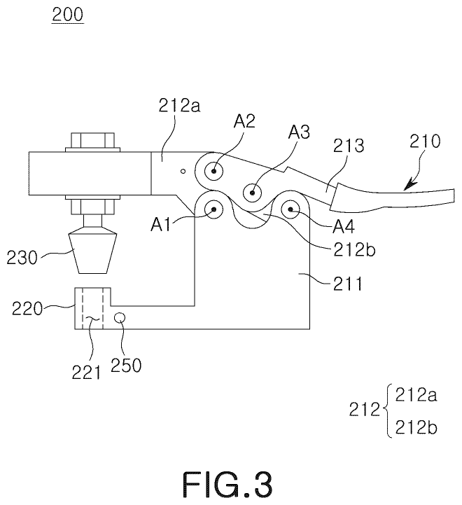

For example, when a component (for example, the housing 120), other than the battery device 100 of FIG. 1, has the fastening hole 124a, dimensions of the component may be inspected by a checking device 200 of FIG. 3.

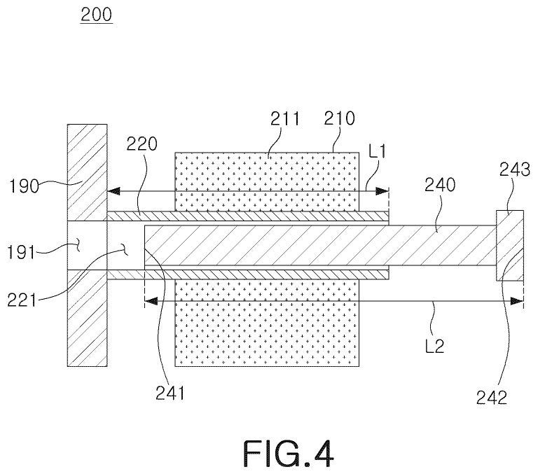

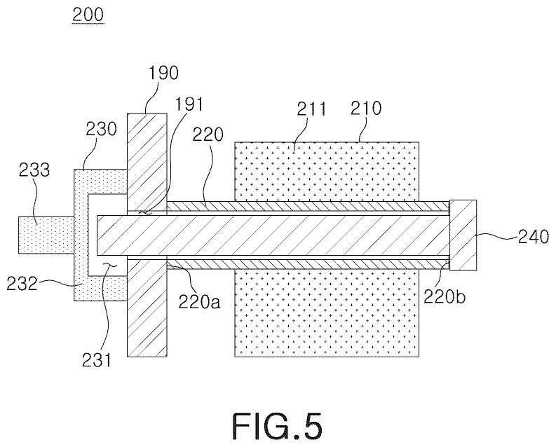

FIG. 3 is a schematic diagram of a checking device according to an embodiment. FIGS. 4 and 5 are diagrams of a checking process of a checking device assembly according to an embodiment.

Referring to FIGS. 3, 4, and/or 5, the checking device 200 may include a clamp 210, a first support member 220, and a second support member 230.

The checking device 200 may fix a position of an object 190. For example, when checking dimensions of the object 190, the checking device 200 may fix the position of the object 190 to provide a reference for dimension measurement. The object 190 may be a component having a fastening hole (for example, the fastening hole 124a of FIG. 2). In an embodiment, the checking device 200 may be referred to as a checking facility or checking fixture. In an embodiment, the checking device 200 may fix a position of a corner portion of the object 190.

The object 190 may be the housing 120 (for example, the upper cover 121, the end cover 122, and/or the side cover 123) of FIG. 1 or the plate 124 of FIG. 2. However, such a configuration may be an exemplary. When the object 190 is a component having a hole (for example, a fastening hole 191), a type and a structure of the object 190 are not limited.

The checking device 200 may provide pressure to the object 190 using the clamp 210. For example, the clamp 210 may include a base 211 and a linkage structure 212 that is at least partially movable relative to the base 211. The clamp 210 may include a grip portion 213 moving based on a user input (for example, external force received from a user or an operator). The grip portion 213 may be connected to the linkage structure 212. The linkage structure 212 may move based on a user input obtained by the grip portion 213. In an embodiment, clamp 210 may be a toggle clamp. In an embodiment, the base 211 may be referred to as a checking device frame, a housing, or a case.

In an embodiment, the checking device 200 may have a 4-bar linkage structure. In an exemplary embodiment, the base 211 may provide a first axis A1 and a fourth axis A4 spaced apart from the first axis A1 by a specified distance. The linkage structure 212 may include a first bar 212a and a second bar 212b respectively rotating about the first axis A1 and the fourth axis A4. The base 211, the first bar 212a, the second bar 212b, and the grip portion 213 may implement a 4-bar linkage structure. The first bar 212a may be connected to the base 211. For example, the first bar 212a may be connected to the base 211 about the first axis A1, and may be connected to the grip portion 213 about a second axis A2. The second bar 212b may be connected to the base 211 about the fourth axis A4, and may be connected to the grip portion 213 about a third axis A3. The grip portion 213 may provide the second axis A2 and the third axis A3 spaced apart from each other by a specified distance. When the grip portion 213 moves based on external force, the linkage structure 212 may also move. For example, when the grip portion 213 moves clockwise, the first bar 212a may move counterclockwise.

The checking device 200 may have a structure capable of visually recognizing a fastening hole 191 of an object 190 of an operator. For example, the first support member 220 may have a through-hole 221 corresponding to the fastening hole 191 of the object 190. For example, the through-hole 221 of the first support member 220 may face the fastening hole 191 of the object 190. According to an embodiment, the through-hole 221 may provide a path through which a checking pin 240 passes.

The first support member 220 may fix a position of the object 190. For example, the first support member 220 may be in contact with the object 190, and may provide external force or pressure to the object 190. In an embodiment, the first support member 220 may be referred to as an external support portion.

The first support member 220 may be attached to or detached from the clamp 210. For example, the first support member 220 may be coupled or connected to the base 211 of the clamp 210 using a fastening member 250. A position in which the first support member 220 is connected to the base 211 may change based on a shape or a type of the object 190. For example, the base 211 may have a plurality of coupling holes (not illustrated) for accommodating the fastening member 250, and the first support member 220 may be coupled to the base 211 in a position in which the fastening hole 191 of the object 190 and the through-hole 221 of the first support member 220 face each other. For another example, lengths of the base 211 and/or the first support member 220 may be designed to be changeable, and the fastening hole 191 of the object 190 and the through-hole 221 of the first support member 220 may face each other.

The first support member 220 may be attached to or detached from the base 211 by the fastening member 250, thereby increasing a degree of freedom in designing a shape of the checking device 200. For example, a position in which the first support member 220 is coupled to the base 211 may be changed. Even when a surface of the first support member 220 has a shape other than an acute angle, a contact area between the first support member 220 and the object 190 may be maintained at a specified size or more.

According to an embodiment, the first support member 220 may have a first surface 220a in contact with the object 190, and a second surface 220b opposite the first surface 220a. Based on movement of the clamp 210, the first surface 220a may provide force to the object 190 and reduce movement of the object 190, together with the second support member 230. The second surface 220b may be in contact with the checking pin 240. The second surface 220b may limit a movement range of the checking pin 240. For example, the second surface 220b may be in contact with a protruding region 243 of the checking pin 240. In an embodiment, the second surface 220b may be referred to as a stopper for the checking pin 240.

The second support member 230 may provide external force or pressure to the object 190. For example, the second support member 230 may include a connection portion 233 connected to the linkage structure 212 of the clamp 210, and a pressurization portion 232 extending from the connection portion 233, the pressurization portion 232 in contact with the object 190. The second support member 230 may move based on an operation of the clamp 210. For example, the second support member 230 may be connected to linkage structure 212, and may move relative to first support member 220 and/or the object 190, based on movement of linkage structure 212. In an embodiment, the second support member 230 may be referred to as an internal support member. The pressurization portion 232 may have an accommodation groove 231. For example, the accommodation groove 231 may be a groove, a recess, or a hole formed in the pressurization portion 232 in a position thereof opposing the object 190. At least a portion of the pressurization portion 232 may be formed of a material (for example, rubber or resin) to prevent the object 190 from slipping.

In an embodiment, the object 190 may be interposed between the first support member 220 and the second support member 230. When a user input is applied to the clamp 210, the first support member 220 and the second support member 230 may provide pressure to the object 190, positioned between the first support member 220 and the second support member 230, and movement of the object 190 may be prevented or reduced. According to an embodiment, the pressurization portion 232 of the second support member 230 may provide external force or pressure to the object 190.

The object 190 may be pressurized by the second support member 230, thereby improving usability of the object 190. For example, the object 190 may be the housing 120 of FIG. 1 or FIG. 2. The second support member 230 may provide pressure to an internal surface of the housing 120. The internal surface of the housing 120 may be supported by the second support member 230, such that the object 190 may be stably pressurized by the support member 230.

According to an embodiment, the second support member 230 may have an accommodation groove 231 for accommodating at least a portion (for example, an end) of the checking pin 240. The accommodation groove 231 may be a groove formed in the pressurization portion 232. The accommodation groove 231 may face the fastening hole 191 of the object 190 and/or the through-hole 221 of the first support member 220. The end of the checking pin 240 may pass through the through-hole 221 of the first support member 220 and the fastening hole 191 of the object 190 to be accommodated in the accommodation groove 231. The accommodation groove 231 may reduce or prevent movement of the second support member 230, caused by insertion of the checking pin 240.

The checking device 200 may include the checking pin 240. The checking pin 240 may be used to determine a position of the fastening hole 191 of the object 190. For example, the checking pin 240 may pass through the through-hole 221 of the first support member 220 to be inserted into the fastening hole 191 of the object 190. In an embodiment, the checking pin 240 may be inserted into the fastening hole 191 of the object 190 having a position fixed by the first support member 220 and the second support member 230. An operator may use the checking pin 240 to determine whether the checking device 200 is installed in a designated position of the object 190. For example, when the checking pin 240 is inserted into the fastening hole 191 of the object 190, the operator may determine that the checking device 200 is installed in the designated position. An operation of fixing and determining the position of the object 190 may be performed by a single checking device 200, using the checking pin 240.

The checking pin 240 may be inserted into the object 190 through the first support member 220. A second length L2 of the checking pin 240 may be longer than a first length L1 of the through-hole 221 of the first support member 220. The through-hole 221 may be a hole passing through the first surface 220a and the second surface 220b of the first support member 220. The first length L1 may be a distance between the first surface 220a and the second surface 220b. The second length L2 may be a distance between a first end 241 and a second end 242 of the checking pin 240.

The checking pin 240 may have a first end 241 opposing the second support member 230, and a second end 242 opposite the first end 241. The second end 242 may have a protruding region 243. For example, a width of the second end 242 may be wider than a width of the first end 241.

In an embodiment, the checking device 200 may not include the checking pin 240. For example, the checking device 200 may be sold separately from the checking pin 240. The checking device 200 may have a bar or rod shape so as to be inserted into the fastening hole 191 of the object 190 and the through-hole 221 of the first support member 220.

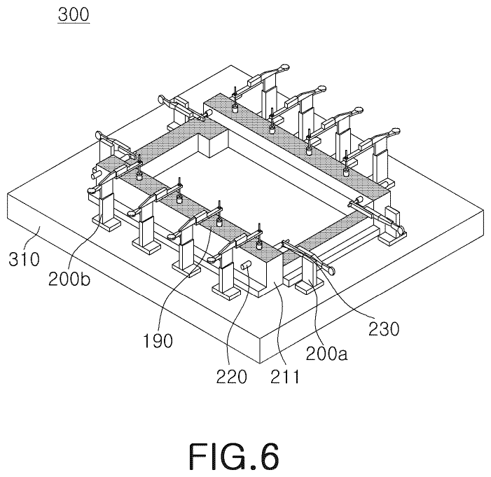

FIG. 6 is a perspective view of a checking device assembly according to an embodiment.

Referring to FIG. 6, a checking device assembly 300 may include a plurality of checking devices 200.

Descriptions of the checking device 200 of FIGS. 3, 4, and/or 5 may be applied to a checking device 200 (for example, a first checking device 200a) of FIG. 6.

The checking device assembly 300 may include a plurality (for example, four) of first checking devices 200a for pressurizing a corner portion of an object 190.

The first checking device 200a may include a base 211 disposed on a frame 310, and a first support member 220 attachable to the base 211. The first support member 220 may face a second support member 230 of the first checking device 200a with the object 190 interposed therebetween. For example, a position of the object 190 may be measured while the object 190 is interposed between the first support member 220 and the second support member 230 of the first checking device 200a.

The checking device assembly may further include a plurality of second checking devices 200b, not including a support member (for example, the first support member 220 of FIG. 4) having a through-hole. The plurality of second checking devices 200b may pressurize an edge of the object 190. A position fixing force for the object 190 may be increased by the checking device 200. For example, the checking device 200 may prevent movement of the object 190 in one direction (for example, an outward direction) using the first support member 220, connectable to the base 211, and may prevent movement of the object 190 in another direction (for example, an inward direction) using a pressurization portion 232.

The checking device assembly 300 may include a frame 310 supporting the checking device 200. The first checking device 200a and the second checking device 200b may be coupled to a frame 311 using a coupling member (for example, a screw).

The features described above are merely examples of the application of the principles of the present disclosure, and other components may be included without departing from the scope of the present disclosure.

Only specific examples of implementations of certain embodiments are described. Variations, improvements and enhancements of the disclosed embodiments and other embodiments may be made based on the disclosure of this patent document. For example, the present disclosure may be implemented by deleting some components from the above-described embodiments, and respective embodiments may be implemented in combination with each other.

What is claimed is:

1. A checking device comprising:
a clamp including a base and a linkage structure connected to the base;
a first support member configured to be fastened to the base, the first support member having a through-hole corresponding to a fastening hole of an object; and
a second support member connected to the linkage structure, the second support member configured to move relative to the first support member, based on movement of the linkage structure,
wherein the second support member faces the first support member with the object interposed therebetween, and
the through-hole accommodates a checking pin configured to pass through the through-hole and the fastening hole.

2. The checking device of claim 1, wherein the second support member has an accommodation groove accommodating at least a portion of the checking pin.

3. The checking device of claim 2, wherein
the second support member includes a connection portion connected to the linkage structure, and a pressurization portion extending from the connection portion, the pressurization portion defining the accommodation groove, and
the pressurization portion is configured to contact with the object.

4. The checking device of claim 1, wherein the first support member is detachably coupled to the base using a fastening member.

5. The checking device of claim 1, wherein the first support member has a first surface configured to contact with the object, and a second surface opposite the first surface, the second surface configured to contact with a protruding region of the checking pin.

6. The checking device of claim 1, wherein the through-hole of the first support member is formed to have a first length, and the checking pin is formed to have a second length, longer than the first length.

7. The checking device of claim 1, wherein
the clamp includes a grip portion connected to the linkage structure, the grip portion for obtaining a user input, and
the linkage structure includes a first bar and a second bar respectively connected to the base and the grip portion.

8. The checking device of claim 7, wherein
the first bar is connected to the base about a first axis, and is connected to the grip portion about a second axis, and
the second bar is connected to the grip portion about a third axis, and is connected to the base about a fourth axis.

9. A checking device comprising:
a clamp including a base and a linkage structure movably connected to the base;
a first support member configured to be fastened to the base, the first support member having a through-hole to correspond to a fastening hole of an object;
a second support member connected to the linkage structure, the second support member configured to move relative to the first support member, based on movement of the linkage structure; and
a checking pin inserted into the through-hole and the fastening hole, the checking pin configured to face the second support member.

10. The checking device of claim 9, wherein the second support member configured to face the first support member with the object interposed therebetween.

11. The checking device of claim 9, wherein the checking pin has a first end opposing the second support member, a protruding region, and a second end opposite the first end.

12. The checking device of claim 9, wherein the second support member has an accommodation groove configured to accommodate at least a portion of the checking pin.

13. The checking device of claim 12, wherein
the second support member includes a connection portion connected to the linkage structure, and a pressurization portion extending from the connection portion, the pressurization portion defining the accommodation groove, and
the pressurization portion is configured to contact with the object.

14. The checking device of claim 9, wherein the first support member is detachably coupled to the base using a fastening member.

15. The checking device of claim 9, wherein
the clamp includes a grip portion connected to the linkage structure, the grip portion for obtaining a user input,
the linkage structure includes a first bar and a second bar respectively connected to the base and the grip portion, the first bar is connected to the base about a first axis, and is connected to the grip portion about a second axis, and
the second bar is connected to the grip portion about a third axis, and is connected to the base about a fourth axis.
